(19) United States
(12) Patent Application Publication
(10) Pub. No.: US 2004/0173144 A1
(43) Pub. Date: Sep. 9, 2004

(54) Formation of printed circuit board structures using piezo microdeposition

(76) Inventors: Charles O. Edwards, Pleasanton, CA (US); David Albertalli, San Jose, CA (US)

Correspondence Address: HARNESS, DICKEY & PIERCE, P.L.C., P.O. BOX 828, BLOOMFIELD HILLS, MI, 48303, US

(21) Appl. No.: 10/479,314

(22) PCT Filed: May 31, 2002
(86) PCT No.: PCT/US02/17369

(51) Int. Cl. B05D 5/12; B05C 15/00

(52) U.S. Cl. 118/300; 427/100

(57) ABSTRACT

A method for manufacturing structure on a printed circuit board substrate according to the invention includes positioning a printed circuit board substrate in a machine capable of performing piezoelectric deposition of a fluid manufacturing material. The printed circuit board substrate is aligned with a piezoelectric deposition head of the machine. Computer numeric control of the relative motion of the printed circuit board substrate and the piezoelectric deposition head allows droplets of the fluid manufacturing material to be deposited at selected locations of the printed circuit board substrate. The printed circuit board substrate includes a conductive surface layer and a masking structure that exposes selected portions of the surface layer, thereby forming traces upon removal of selected portions of the surface layer. Further, the structure manufactured on the printed circuit board may be a resistor.

### CROSS-REFERENCE TO RELATED APPLICATIONS

This application claims the benefit of U.S. Provisional Patent Application Serial No. 60/295,118, entitled “Formation of Microstructures Using Piezo Deposition of Liquid Onto Substrate,” filed Jun. 1, 2001, and U. S. Provisional Application Serial No. 60/295,100, entitled Formation Of Printed Circuit Board Structures Using Piezo Deposition Of Liquid Onto Substrate, filed Jun. 1, 2001, each of which is incorporated herein by reference.

### DISCUSSION OF THE INVENTION

The present invention relates to deposition of fluid materials on printed circuit board substrates using piezoelectric microdeposition (PMD) in controlled quantities in placements to manufacture or create microstructures.

During recent decades, manufacturers have developed various techniques for creating microstructures on substrates such as printed circuit boards. Most of these manufacturing techniques are relatively expensive to implement and require large volumes of throughput to be economically feasible.

In particular, manufacturing of circuit board traces requires several steps. Initially, a copper coated fiberglass substrate is treated with a photoresist material. A mask or template with openings is placed over the photoresist material, revealing only the portions of the board where the traces are to be formed. Ultraviolet light is then applied to the photoresist material, curing and hardening the exposed photoresist material. Next, the substrate is cleaned with a compound to remove all of the photoresist material that has not been cured, thereby exposing selected portions of the surface of the substrate. Next, the substrate is exposed to acid etch bathes, one to remove the copper that is not covered by the photoresist material, and one to remove the cured photoresist. This leaves only copper traces that correspond to the openings in the original template.

Another problem with existing circuit board manufacture is the assembly of resistors that are required for working circuit architectures. In particular, resistors, although they are typically very small, add to the overall volume of the circuitry architecture, thereby limiting the minimization and practical architecture of a circuit. In addition, resistors are generally soldered to the surface of the printed circuit board, which requires additional manufacturing steps. Thus, printed circuit board manufacturing requires many steps and is expensive, particularly when only a single prototype or a small number of boards are to be manufactured.

The present invention relates to piezoelectric microdeposition (PMD) processes for forming structures on a substrate. The PMD process uses a PMD tool, which includes a head to deposit a fluid material on a substrate in a manufacturing process to manufacture electronics. The PMD manufacturing processes of the invention are capable of depositing fluid material with high precision on substrates. The PMD heads are coupled with computer numerically controlled systems for precisely depositing droplets of the fluid material on selected locations of substrate. The PMD systems of the invention are useful in clean room environments where contamination is to be avoided. Accordingly, it has been found that the PMD processes of invention are useful for manufacturing printed circuit boards and various structures that are formed on printed circuit boards.

For instance, the PMD processes of the invention can be used to deposit a patterned material that functions as a replacement for photoresist material. The patterned material, upon being deposited on the substrate, is ready to be used as a mask in subsequent operations, and does not require the multiple steps associated with curing and selective removal that have been associated with photolithography. In addition, the PMD processes can be used to form traces directly on a substrate and to form resistors on printed circuit boards. Also, text or graphic images such as legends can be printed on the printed circuit board as part of the manufacturing process.

One significant advantage of the invention is that the PMD processes, in combination with computer numerically controlled systems, can be used to create prototypes or small numbers of printed circuit boards without incurring high costs.

The invention also extends to various techniques that are used in combination with PMD heads to provide a high degree of accuracy or otherwise to enable microstructures to be formed. For instance, the relative position between a substrate and a PMD head can be adjusted and selected using automated alignment with digital cameras. In order to precisely deposit controlled quantities of fluid material, digital cameras or other optical sensors are used to analyze the drop angle and drop volume generated by the nozzles of the PMD heads. In order to adjust for variations in drop volume and drop angle and to precisely position structures on the substrate, microclocking can be used to increase the temporal resolution by which the nozzles of the PMD heads are controlled. The PMD systems can move the substrates with respect to the PMD head in various ways. In one embodiment, a stage on which the substrate is positioned moves in the X and Y directions in order to form a two dimensional or three dimensional structure on the substrate. In other embodiments, the PMD tool is rotated and/or moved in one linear direction in combination with motion of the stage.

In order to allow a wide variety of structures to be formed, PMD systems of invention can be used with multiple heads and to deposit different liquids to the substrate. PMD systems can also heat the heads or the substrate and control air flow to regulate the drying or curing of the liquids after the liquids have been deposited on to the substrate.

Depending on the nature of the fluid material and the structures to be formed, some or all the features described below can be used in combination with the basic process of depositing fluid material using a PMD head. It has been found that manufacturing processes can be greatly simplified and made less expensive using the PMD techniques of the invention. This allows manufacturing runs of smaller numbers of individual devices to be economically feasible.

These and other features of the present invention will become more fully apparent from the following description and appendices, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of one embodiment of the PMD system of the invention;

FIG. 2 illustrates a side view of the PMD system of FIG. 1;

FIG. 3 illustrates a front view of the PMD system of FIG. 1;

FIG. 4 illustrates a top view of the PMD system of FIG. 1;

FIG. 5 illustrates a perspective view of one embodiment of a mounting bracket configured for coupling a PMD head to a PMD head support in the PMD system of FIG. 1;

FIG. 6 illustrates a side view of the mounting bracket of FIG. 5 connected with a PMD head support that includes tubing of the fluid manufacturing supply system and a solvent supply system;

FIG. 7 illustrates a side view of the mounting bracket and PMD head support of FIG. 6 in which a PMD head has been mounted onto the mounting bracket and in which the tubing has been connected to the PMD head;

FIG. 8 illustrates one embodiment of the PMD system of the invention that includes a computer configured for controlling the PMD system and components;

FIG. 9 illustrates the mounting bracket, PMD head, and PMD head support of FIG. 7 in which the mounting bracket and PMD head have been rotated on the PMD head support by 90°;

FIG. 10 illustrates a capping station of the PMD system that includes a tray, an extendable support, and a soaking reservoir;

FIG. 11 illustrates a front view of a docking station configured for mounting a PMD head during nonuse and for mounting a supply of the fluid manufacturing material in a pressure sensitive and pressure controllable working bag;

FIG. 12 illustrates a side view of the docking station of FIG. 11;

FIG. 13 illustrates a front view of the docking station of FIG. 11 with a PMD head mounted on the docking station;

FIG. 14 illustrates one embodiment of a PMD head support comprising a linear air bearing assembly; and

FIG. 15 illustrates one embodiment of a configuration of the PMD system that includes a plurality of PMD head supports mounted on linear air bearing assemblies.

### DETAILED DESCRIPTION OF THE PREFERRED EMBODIMENTS

The present invention is directed to piezoelectric microdeposition (PMD) of fluid materials on substrates in controlled quantities and placements to manufacture or create microstructures. In particular, the invention is directed to PMD of fluid materials in the manufacture of electronics.

The terms “fluid manufacturing material” and “fluid material,” as defined herein, is broadly construed to include any substance that can assume a low viscosity form and which is suitable for PMD. Suitable materials include, but are not limited to, plastics, metals, waxes, solders, solder pastes, biomedical products, acids, photoresist materials, solvents, adhesives and epoxies. Other suitable materials include high inductance polymers that can be used to form resistors and light emitting polymers (LEPs), which can be used to form polymer light emitting diode display devices (PLEDs, and PolyLEDs).

The term “deposition” as defined herein, generally refers to depositing individual droplets of fluid materials on substrates. The terms “jet,” “deposit,” and “print” are used interchangeably herein to refer to the deposition of fluid material onto a substrate. The terms “droplet” and “drop” are also used interchangeably herein.

The term “substrate,” as defined herein, is broadly construed to include any material having a surface that is suitable for receiving a fluid material during a PMD process. Suitable substrate materials include, but are not limited to, silicon wafers, glass plates, ceramic tiles, fiberglass boards, rigid and flexible plastic and metal sheets and rolls. It should also be appreciated that in certain embodiments, deposited fluid materials may also themselves comprise suitable surfaces for receiving fluid material deposits during a PMD process, as described below.

The term “microstructures,” as defined herein, generally refers to structures formed with a high degree of precision, and that are sized to fit on a substrate. Inasmuch as the sizes of different substrates may vary, the term “microstructures” should not be construed to be limited to any particular size and can be used interchangeably with the term “structure”. Microstructures may include a single droplet of a fluid material, any combination of droplets, or any structure formed by depositing the droplet(s) on a substrate, such as a two-dimensional layer, a three-dimensional architecture, and any other desired structure.

The PMD systems of the invention perform PMD processes by depositing fluid materials onto substrates according to user-defined computer-executable instructions. The term “computer-executable instructions,” which is also referred to herein as “program modules” or “modules,” generally includes routines, programs, objects, components, data structures, or the like that implement particular abstract data types or perform particular tasks such as, but not limited to, executing computer numerical controls for implementing the PMD processes of the invention. Program modules may be stored on any computer-readable media, including, but not limited to RAM, ROM, EEPROM, CD-ROM or other optical disk storage, magnetic disk storage or other magnetic storage devices, or any other medium capable of storing instructions or data structures and capable of being accessed by a general purpose or special purpose computer.

According to the invention, an ink jet head can deposit fluid manufacturing materials in manufacturing environments to form any of a wide variety of structures by patterning fluid manufacturing materials on a substrate according to the PMD processes of the invention, as best described in contemporaneously filed PCT Patent Application No. ______, filed May 31, 2002, entitled Microdeposition Apparatus; PCT Patent Application No. ______, filed May 31, 2002, entitled Temperature Controlled Vacuum Chuck; PCT Patent Application No. ______, filed May 31, 2002, entitled Industrial Microdeposition System For Polymer Light Emitting Diode Displays, Printed Circuit Boards And The Like; PCT Patent Application No. ______, filed May 31, 2002, entitled Interchangeable Microdeposition Head Apparatus And Method; PCT Patent Application No. ______, filed May 31, 2002, entitled Waveform Generator For Microdeposition Control System; PCT Patent Application No. ______, filed May 31, 2002, entitled Over-Clocking In A Microdeposition Control System To Improve Resolution; and PCT Patent Application No. ______, filed May 31, 2002, entitled Apparatus For Microdeposition Of Multiple Fluid Materials; each of which is incorporated herein by reference. Many structures can be manufactured according to the invention less expensively, more efficiently, and more accurately than the same structures manufactured using conventional techniques. Other structures that can be manufactured using PMD processes cannot be manufactured in conventional ways. Moreover, the PMD processes of the invention are compatible with clean room environments and with fluid manufacturing materials that cannot be contaminated during or after the manufacturing processes.

According to one embodiment, the PMD systems of the invention generally includes a stage, a vacuum chuck, a PMD head, a PMD head support, an alignment component, a fluid material supply system, a drop diagnostics assembly, a maintenance station, a capping station, a docking station, and a computer system. The computer system provides the PMD system with computer-executable instructions and controls the various components of the PMD system.

In order to deposit fluid material and/or form microstructures on a substrate, it is useful for the PMD tool to move relative to the substrate. The relative motion of the PMD head and the substrate can be achieved by moving the substrate and/or the PMD head. This movement may be linear or rotational.

For linear motion, the PMD system may use a linear motor. In one embodiment, the PMD system includes a linear motor that is configured for a clean room environment, having air bearings so that linear motion of the PMD head does not create any particles from friction that can contaminate the clean room environment. The PMD system may also include hepa filters, special bearings, motors, and assemblies to meet the stringent clean room requirements. The mobility provided by the linear motor is also beneficial for enabling PMD processes to be performed on large substrates, such as on rolls of plastic that cannot be rotated by the stage.

In certain embodiments, the PMD system includes means for rotating the PMD head to accommodate large substrates and certain PMD process requirements. Means for rotating the PMD head may include, but are not limited to, air bearings and magnetic relays. Rotating the PMD head is particularly useful for providing a pitch or angle of the nozzles with respect to the direction in which the fluid material is deposited on the substrate when it is impractical to rotate the stage, thereby decreasing the space between the deposited fluid material and increasing the resultant resolution.

Resolution can also be improved when straight lines are deposited on the substrate by rotating the PMD system and/or substrate so that the substrate moves in the same direction as the line(s) to be deposited. In this manner, each droplet that is deposited on the substrate will land on the track or tail of the previous droplet, thereby minimizing the effects of any irregularly shaped droplets and improving the overall resolution of the sides of the line(s).

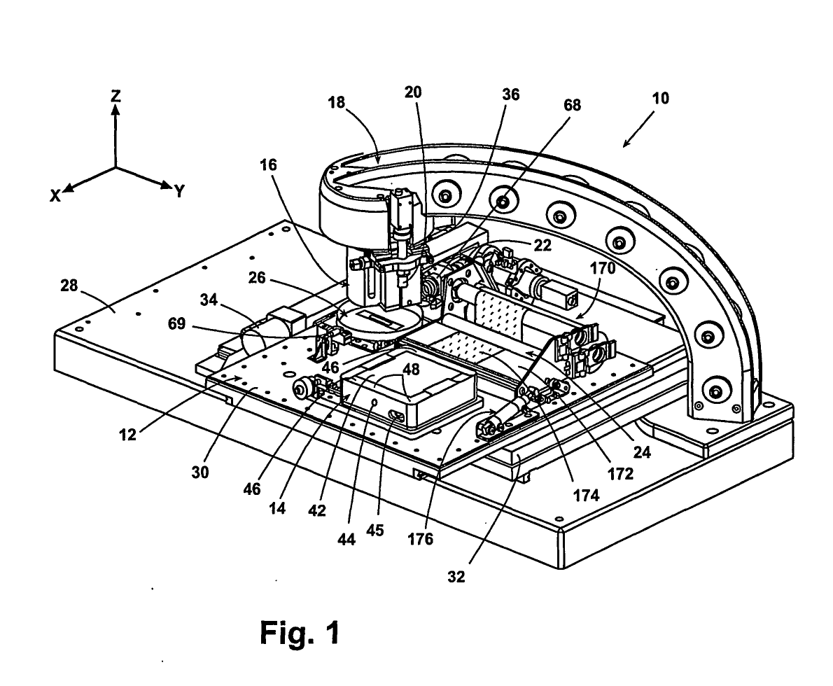

FIG. 1 illustrates several components of the PMD system 10, including the stage 12, the vacuum chuck 14, the PMD head 16, the PMD head support 18, the alignment component 20, the drop diagnostics assembly 22, the maintenance station 24, and the capping station 26.

As shown, the stage 12 and the PMD head support 18 are mounted to a fixed surface 28. The fixed surface 28 may include any surface suitably configured to provide stability to the PMD system 10 and to minimize vibrations capable of compromising the precision of the PMD system 10 during use. According to one embodiment, the fixed surface 28 includes a granite block. However, it will be appreciated that the fixed surface 28 may also include other materials and structures.

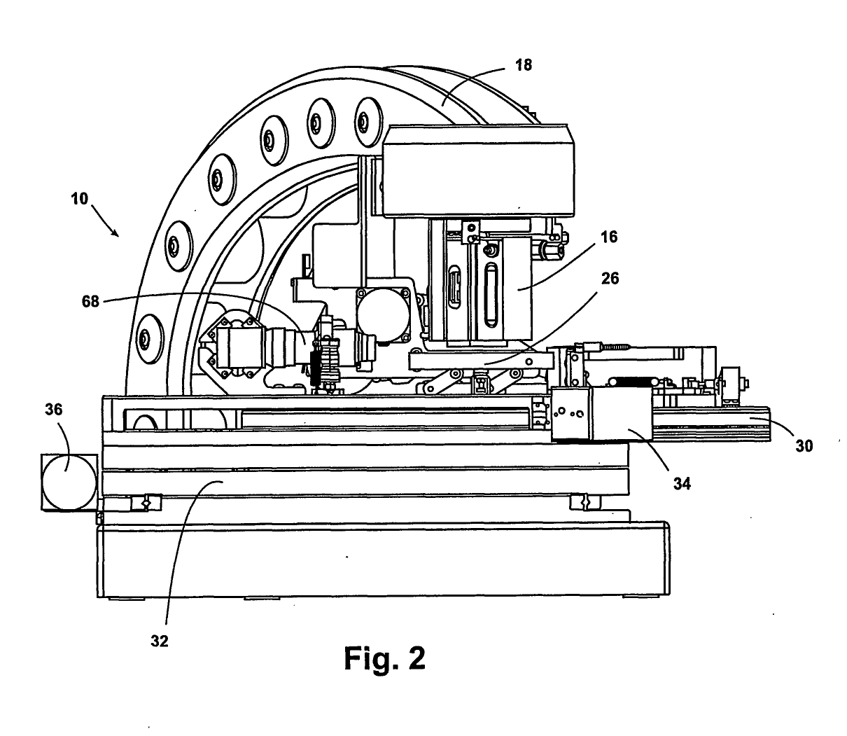

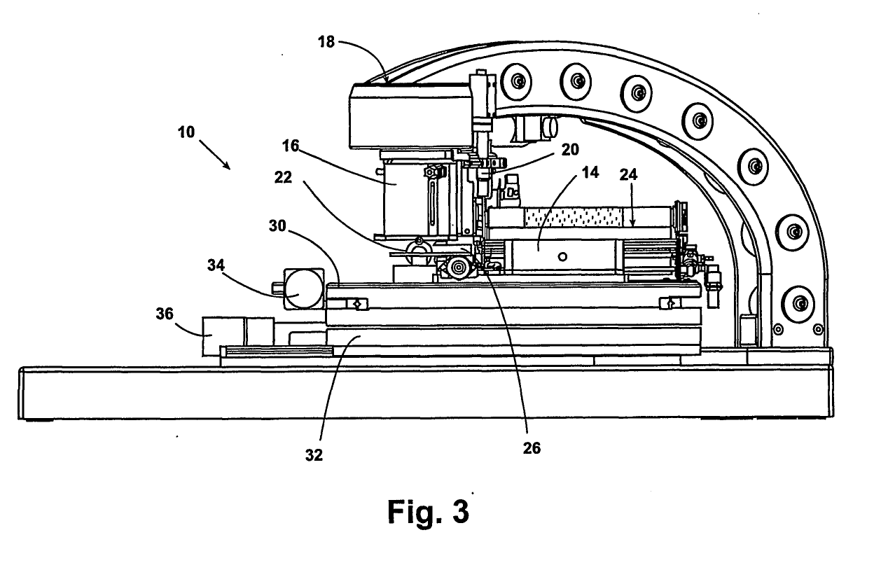

FIGS. 2 and 3 illustrate the respective side and front views of the PMD system 10 of FIG. 1. As shown, the stage 12 comprises a top mounting plate 30 and an intermediate plate assembly 32, each of which is configured to move in one of two different directions. As shown in FIGS. 1-3, the vacuum chuck 14, the capping station 26, the maintenance station 24, and the drop diagnostics assembly 22 are mounted on the top mounting plate 30 of the stage 12, and will therefore move with the top mounting plate 30.

In particular, the top mounting plate 30 is connected to a first motor 34 configured to drive the top mounting plate 30 in a first direction, illustrated as the X axis in FIG. 1, and the intermediate plate assembly 32 is connected to a second motor 36 configured to drive the intermediate plate assembly 32, as well as the top mounting plate 30, in a second direction, shown as the Y axis in FIG. 1. The first and second motors 34 and 36 may be operated exclusively or simultaneously to provide any desired movement of the stage 30, relative to the PMD head 16, in the horizontal X-Y plane. Accordingly, it will be appreciated that the stage 12 is also capable of moving simultaneously in both the X and Y directions of the X-Y plane. The mobility of the stage 12 in the X-Y plane is useful for moving a substrate mounted on the stage 12 into alignment with the PMD head 16 and for moving the substrate during the PMD processes of the invention, as generally described below. It will be appreciated that the stage 12, as configured, is configured for clean room environments, where moving parts, particularly moving parts that have solid surfaces moving against each other, generally cannot be used if the parts are positioned above the substrate.

The vacuum chuck 14 provides one suitable means for securing a substrate in a fixed position on the stage 12 during the PMD processes of the invention. Other structures and methods for retaining the substrate, including a roll-to-roll assembly for flexible materials, are considered within the scope of the invention.

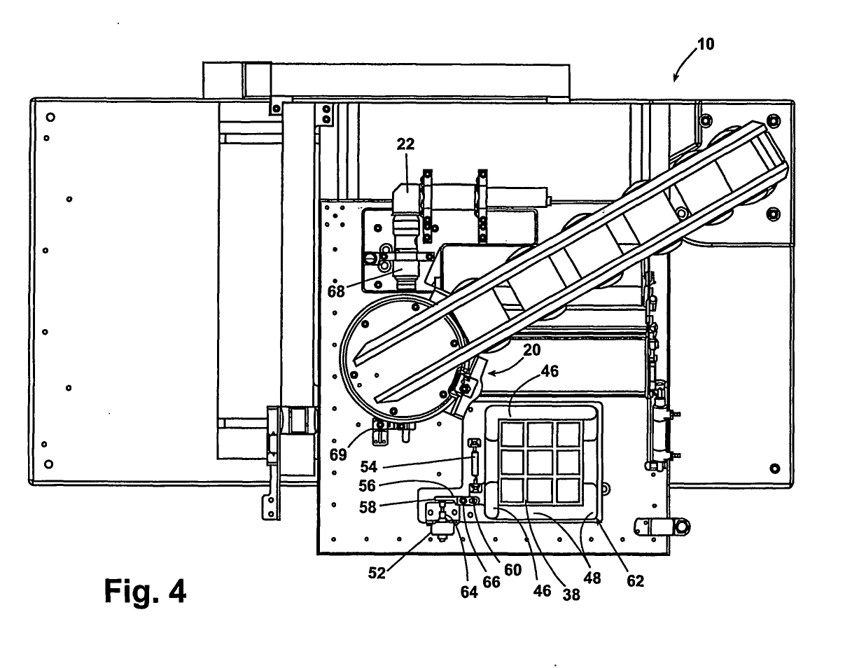

A substrate 38, shown in FIG. 4, is securely held in place on the vacuum chuck 14 by negative air pressure created by the suctioning of air through the porous metal plate 42 of the vacuum chuck 14. The porous metal plate 42 can be seen in FIG. 1. According to one embodiment, the porous metal plate 42 is a porous aluminum plate, such as Metapor®, available from Portec Ltd., a subsidiary of M-Tec Holding Ltd. Winterthur. However, other types of porous plates manufactured from other materials can also be used. Air is suctioned through the porous metal plate 42 by any suitable means, such as a vacuum or a pump, which can be connected to a suction port 44 on the vacuum chuck 14.

The vacuum chuck 14 may also include a coupling 45, which can be configured to interconnect devices within the vacuum chuck 14 with control devices of the PMD system 10. The coupling 45 provides a serial port through a DB9 connector, for example, which couples devices within the vacuum chuck 14 with a control system. According to one embodiment, a heating source and temperature sensors are contained within the vacuum chuck 14 and are connected with a control system to enable an operator to control the temperature of the porous metal plate 42.

As shown in FIG. 4, a substrate 38 can be mounted on the vacuum chuck 14 between ledge supports 46 that are configured to align the substrate 38 on the vacuum chuck 14. Alignment of the substrate 38 on the vacuum chuck 14 is useful to ensure fluid manufacturing material is deposited on the substrate 38 in the appropriate locations. It should be noted, however, that the act of mounting the substrate 38 on the vacuum chuck 14 does not ensure that the substrate 38 is aligned with the PMD head 16 to the precise tolerances that are required to perform the PMD processes of the invention. Thus, the substrate 38 should be precisely aligned with the PMD head 16 according to the methods of the invention.

Initial alignment between the substrate 38 and the PMD head 16 is provided when the substrate 38 is mounted on the vacuum chuck 14 against the ledge supports 46 because the vacuum chuck 14 is already aligned with the PMD head 16. In order to ensure the vacuum chuck 14 is precisely aligned with the PMD head 16, two reference points 48 are provided on the vacuum chuck 16. The reference points 48 are optically detected by an alignment component 20, discussed in more detail below, which generally determines whether the vacuum chuck 14 is in proper alignment with the PMD head 16. If the vacuum chuck 14 is not in proper alignment then the vacuum chuck 14 is moved until the desired alignment is obtained.

To provide proper alignment of the vacuum chuck 14 and the substrate 38, the vacuum chuck 14 includes a stepper motor 52, a spring 54, and a pivot arm 56. The pivot arm 56 is connected with the stepper motor 52 at a first end 58 and is connected with the vacuum chuck 14 and a spring from a second end 60. The vacuum chuck 14 is also pivotally connected with the stage 12 at a pivot corner 62. This generally enables the vacuum chuck 14 to pivot about the pivot corner 62 when the stepper motor is operated.

According to one embodiment, the stepper motor includes an extension arm 64 that can be controllably extended to apply a force to the first end 58 of the pivot arm 56, thereby causing the pivot arm 56 to pivot in a clockwise rotation (from the top view of FIG. 4) about a pivot point 66. Because the second end 60 of the pivot arm 56 is connected with the vacuum chuck 14, this causes the vacuum chuck 14 to pivot about the pivot corner 62 in a counterclockwise rotation. The vacuum chuck 14 can also be pivoted in the opposite direction. For instance, when the arm 64 of the stepper motor 52 is retracted, the spring 54 contracts and forces the second end 60 of the pivot arm 56 to move towards the spring 54, thereby causing the vacuum chuck 14 to pivot about the pivot corner 62 in a clockwise rotation.

Pivoting of the vacuum chuck 14 may be performed by the PMD system 10 at any time to obtain a desired alignment of the vacuum chuck 14 or the substrate 38 with the PMD head 16. Pivoting the vacuum chuck 14 can also be performed to create a desired misalignment of the substrate 38 with the PMD head, which may be desired when forming certain microstructures on the substrate 38. According to one embodiment, desired alignment between the substrate 38 and the PMD head 16 can also be obtained by rotating the PMD head 16 with respect to the substrate 38 at the PMD head support 18, such as for example, with a turret, as described below.

Specific reference is now directed to the alignment component 20. As shown in FIGS. 1 and 3, the alignment component 20 is fixedly attached to the PMD head support 18. According to one embodiment, the alignment component 20 comprises a camera. The camera may have any combination of digital and optical capabilities and is preferably linked to optical/digital recognition modules that are configured to identify the reference points 48 on the vacuum chuck 14, as well as precise alignment marks etched on the substrate 38. These alignment marks, which are referred to herein as fiducial marks, are typically preformed on the substrate 38 and are generally too small to be seen by the naked eye. In one embodiment, the fiducial marks include perpendicular cross-hairs etched on the substrate 38.

Fiducial marks are used, according to one embodiment, as a basis for aligning the substrate 38 with the PMD head 16 because alignment to the edge of the substrate 38 alone is typically not accurate enough to form microstructures on the substrate 38 with the precision that is required for manufacturing certain products. For example, in one embodiment, the PMD system 10 deposits polymer droplets onto pixels of a PLED display within plus or minus about ten microns, which is roughly one-tenth the diameter of the human hair. It will be appreciated that the ability of the PMD systems of the invention to precisely deposit fluid manufacturing material with such accuracy is an improvement over the prior art.

When the substrate 38 is mounted on the vacuum chuck 14, the PMD system 10 automatically uses the camera and optical recognition modules associated with the alignment component 20 to identify the fiducial marks or other reference markings on the substrate 38. The vacuum chuck 14 or PMD head 16 is then automatically pivoted or rotated, as required, to correct any misalignment between the PMD head 16 and the substrate 38. In this manner, alignment existing between the PMD head 16 and the substrate 38 is obtained, in a matter of seconds, to tolerances within about 3 microns. Finally, once the desired alignment is obtained, the PMD system 10 is capable of precisely depositing droplets of the fluid material onto predetermined locations of the substrate 38 according to the processes of the invention.

According to one embodiment, microstructures are formed on the substrate 38 as droplets are deposited from the PMD head 16 while the substrate 38 is moved beneath the PMD head 16 on the stage 12. For instance, rows of droplets can be formed on the substrate 38 when the stage 12 moves the substrate 38 below the PMD head along the X axis. The stage 12 can also be moved along the Y axis between the deposition of rows, thereby enabling a plurality of rows to be formed. The stage can also be moved in any combination of directions along X and Y axis to enable a variety of structures to be precisely formed over any portion of the substrate.

Although alignment of the substrate 38 with the PMD head 16 can be adjusted, as described above, it can be thwarted when the nozzles of the PMD head. 16 do not fire properly. The PMD head 16 may include, for example, any number of nozzles. According to one embodiment, the PMD head 16 includes a nozzle assembly (not shown) having between about one and about 256 nozzles. If even a single nozzle is misfiring then the alignment of the substrate 38 with the PMD head 16 can be defeated. Accordingly, it is important to identify the firing characteristics of each nozzle and to correct any firing irregularities that may exist. Once the firing characteristics of the individual nozzles are known, it is possible to individually control the nozzles with the computer modules of the invention to achieve the desired discharge of the fluid material from the nozzles.

The drop diagnostics assembly 22, shown in FIGS. 1-4, is provided to measure and identify the firing characteristics of the individual nozzles of the PMD head 16. The drop diagnostics assembly generally includes a camera 68, which may have any combination of digital and optical capabilities, and is preferably linked to optical/digital recognition computer modules that are configured to identify the different firing characteristics of the individual nozzles.

According to one embodiment, the drop diagnostics assembly 22 identifies the firing characteristics of the individual nozzles by capturing various images of the droplets as they are discharged out of the nozzles and by analyzing the drop characteristics of the droplets. If a single nozzle of the PMD head is not firing properly, the drop diagnostics assembly and corresponding modules detect the error. The PMD system 10 then tries to automatically repair the nozzle with maintenance procedures, which are described below. If the error cannot be automatically corrected, the PMD system 10 warns the operator and manufacturing is paused, thereby preventing costly losses in device yields. The PMD head 16 can then be repaired or replaced by the operator, if required.

According to one embodiment, the camera 68 of the drop diagnostics assembly 20 is a right-angle camera 68 configured to fit on the stage 12. A backlight, such as strobe light 69, is also provided to enhance the quality of the images captured by the camera 68 and for capturing an image of the droplet in flight, as is well known in the art of photography. To perform drop diagnostics, the PMD head 16 is moved between the camera 68 and the strobe light 69, above the capping station 26. Droplets are then discharged from the nozzles of the PMD head 16 into the capping station 26. The characteristics of the droplets and the firing characteristics of the nozzles are then determined, as described below, upon capturing two orthogonal images of the droplets discharged from the nozzles. It is preferred that the nozzles being tested are centered in the camera's field of view for maximum accuracy and that they are tested individually.

According to one embodiment, a first image is taken of a first droplet when the PMD head is in a first position and the second image is taken of a second droplet fired from the same nozzle after the PMD head 16 has been rotated by 90 degrees. According to another embodiment, the two images are taken simultaneously of a single droplet using two orthogonally mounted cameras. Upon capturing the images of the droplets, the optical recognition modules of the PMD system 10 use the images and firing information to calculate the drop volume, drop velocity, drop nozzle placement, drop angle of deviation, and drop formation, thereby enabling the PMD system 10 to compensate for any deficiencies or variation between the nozzles of the PMD head 16.

Drop volume may be calculated by using the height and/or width of the droplet, or imaging the area by one or more cameras to calculate the volume. In both variations, the images captured by the camera 68 are used to calculate or estimate the three-dimensional shape of the droplet, depending on the required accuracy and precision for a particular application. If the droplet volume is too large or too small, the PMD system 10 automatically compensates by adjusting the frequency at which the nozzle discharges the droplets. For instance, the amount of voltage or the wavelength sent to the PMD head 16 can be varied to compensate for the flawed drop volume. With less power, a smaller droplet will be ejected; with more power, a larger droplet will be ejected. Once a correction is made, it may be necessary to reanalyze the nozzle and corresponding droplets in an iterative process to refine the adjustments.

A second way to correct problems associated with drop volume is to change the number and frequency of the droplets that are deposited during the PMD process. Although the drop volume of individual droplets will remain the same according to this method, the quantity of fluid material deposited on the substrate can be controlled by increasing or decreasing the frequency at which the droplets are deposited. This method of compensating for problems with drop volume is particularly useful when depositing droplets in rows or when multiple drops are needed to achieve the desired drop volume. This method of altering the frequency at which the droplets are deposited is referred to herein as microclocking.

Microclocking is one means provided by the invention for overcoming deposition speed performance limitations such as starvation, which refers to the condition in which fluid material is not replenished into the fluid chamber quickly enough to be jetted out of the nozzle. Existing print head technologies typically limit the clock frequency of the print head to the maximum frequency at which printing can be accomplished before starvation occurs. It should be appreciated by one skilled in the art that this also places practical limits on the resolution of the PMD head, particularly when considering that multiple nozzle heads typically work off of a single clock.

To overcome the limitations of the prior art and to obtain individual control over the nozzles of the PMD tool, the present invention utilizes a method of microclocking to artificially increase the frequency of clock cycles or signals sent to the PMD tool far beyond the intended deposition speed. The PMD system is able to use the additional clock cycles to control the resolution and the quantity of fluid material deposited during the PMD process. In one embodiment, the PMD system increases the frequency of clock cycles by a ratio of 10 to 1 over the intended deposition speed, thereby providing the PMD system with the ability to control the dot placement within one tenth of the deposition frequency.

Even though the deposition frequency cannot exceed the limitations of starvation, it is still possible to send clock cycles and data to the PMD tool at the microclock rate because the computer-executable instructions of the PMD system will not permit the actual deposition data to exceed the starvation rate. This is accomplished in the present embodiment, by sending “filler data,” or blank data to each nozzle approximately 9 out of every 10 clock cycles. The PMD tool therefore receives multiple times more data than it can use to deposit proportional to the microclock divided by the actual deposition clock speed. In this manner, it is possible to increase the resolution of existing print head technology by 10 times or more without impacting the maximum deposition speed.

Microclocking is particularly beneficial for improving resolution of the deposited fluid material on a substrate. In particular, the beginning and ending of a line or shape can be more precisely controlled. In the current embodiment, in which the frequency of clock cycles is set at a ratio of 10 to 1 over the intended deposition speed, the fluid material can be deposited by the PMD tool ten times more precisely than previously allowed, to within one-tenth of the previous width of allowed resolution at the same deposition speed.

Microclocking is also useful for controlling the volume of the fluid material that is deposited on the substrate. For example, if it is desirable to have more fluid deposited to either compensate for a weak nozzle or to just add to the material thickness, the appropriate nozzle is set to jet a droplet of the fluid material at a higher frequency than the other nozzles. For example, the designated nozzle may be set to jet 1 out of every 9 clocks where the other nozzles are jetting 1 out of every 10 clocks. This technique deposits approximately 11% more fluid material by the designated nozzle than from the other nozzles. Similarly, nozzles that otherwise deposit too much fluid can be caused to deposit less frequently.

Microclocking is also particularly useful when the PMD tool is rotated and the nozzles are not vertically aligned, when trying to accommodate for differences in drop velocity or angle of deviation, when higher resolution is desired for placing individual dots, and when there is a desire to carefully control fluid quantities that are deposited on the substrate.

Microclocking, as it has been described, generally requires the frequency of clock cycles sent to the PMD tool to be multiple times higher than the intended deposition frequency. The ratio of the microclocking frequency to the deposition frequency controls the potential increase in resolution. The computer-executable instructions that produce the dot patterns for jetting the fluid material must recognize the potential increase in resolution and inject “filler data” of zeros to be sent to the PMD tool for the wait cycles. The number of wait cycles to each deposition cycle equals the ratio of the microclocking frequency to the deposition frequency.

Microclocking is also useful for compensating for “pitch,” which is the rotation of the PMD tool relative to the motion of the substrate during the PMD process. Pitching the PMD tool results in a resolution that is accurate to within a fraction of a dot, based on the ratio of the microclocking frequency to the actual deposition frequency. Microclocking compensates for pitch by injecting “filler data” which equals the space created by the offset of the angled nozzles relative to the vertical motion of the substrate.

Drop velocity is calculated by taking the time delay from the nozzle fire time (Tf) and the camera strobe fire time (Ts) to obtain the travel time Tf−Ts=Tt. The optical recognition module is then used to find the distance traveled (Dt), which is the distance between the center of the droplet and the nozzle. The drop velocity is finally calculated by dividing the distance traveled by the travel time (Dt/Tt).

Drop velocity determines when the drops of fluid material hit the substrate, which is particularly significant when the substrate is moving. Problems with drop velocity are corrected by offsetting the firing time of the droplets to compensate for drop velocities that are too high or too low. Calculating an adjustment for the firing time can be determined, according to the invention, because the drop velocity and the distance to the substrate are known. For drop velocities that are too high, the firing time is delayed; for drop velocities that are too low, the firing time is accelerated.

Drop nozzle placement is determined by adjusting the illumination cycle of the strobe light 69 until the droplet is photographed leaving the nozzle. Then the exact location or placement of the nozzle can be identified. Correction for an irregular drop nozzle placement is made in conjunction with correction for drop angle of deviation, as discussed next.

Drop angle of deviation is determined by jetting a drop of the fluid material out of the nozzle a predetermined distance (which can be done because of the known drop velocity) and then identifying the center of the drop at that distance. Next, the center of the droplet and the drop nozzle location are used to calculate the angle of deviation. According to one embodiment, this is done in both the X and Y directions of a horizontal X-Y plane to get the true three-dimensional drop angle of deviation.

Drop angle of deviation and irregular drop nozzle placement are corrected by taking the nozzle placement and the angle of deviation and calculating where the droplet will fall compared to where it is expected to fall. Next, the firing time is accelerated or delayed to compensate for any discrepancies between the expected and actual trajectory of the droplet.

Drop formation is determined by analyzing the images captured by the camera 68 with the optical recognition modules to see if there are any anomalous shapes outside of the main droplet. Primarily, this is done to check whether the droplet has significant tails or corresponding satellites. The term “satellites” generally refers herein to fluid material discharged contemporaneously with the droplet, but which has become detached from the droplet.

Drop formation analysis is a pass/fail test. If the droplet does have an anomalous shape or corresponding satellites, the PMD system automatically corrects the problem in one of two general ways. The first option is to change the voltage and pulse width settings of the nozzle discharging the droplet with computer-executable instructions from the PMD system 10. This type of correction is typically performed when a new fluid material or PMD head 16 is being used and flaws are widespread across the entire nozzle assembly of the PMD head 16. When the PMD head 16 and fluid material are not new, however, it is likely that the nozzles of the PMD head are clogged or in need of repair. Accordingly, the second option for correcting undesired drop formation is to perform maintenance on the PMD system 10 to unclog or repair the nozzles of the PMD head 16. If automatic maintenance cannot repair the nozzles, the machine warns the user before proceeding, thereby avoiding unnecessary waste to materials and products. This is critical for high yield and costly manufacturing processes.

The drop diagnostics assembly 22 and alignment component 20 of the PMD system 10 represent an Innovation over existing printing technologies because of the accuracy enabled by the drop diagnostics assembly 22 and alignment component 20. Moreover, existing printing and patterning systems do not have the ability to measure or precisely align the position, angles, and operation of the nozzles with a substrate 38, nor has there been any motivation in such systems to provide the precise alignment necessary for high yield and costly manufacturing processes. The development of these systems for aligning the PMD head 16 and corresponding nozzles with the substrate 38 enables the PMD processes of the invention to create microstructures that require a high degree of precision.

The infinite variable positioning provided by the PMD system 10 according to the invention provides uniformity over a large area. Further, the PMD system 10 according to the invention controls pitch in addition to movement in the x and y axes. More specifically, rotation of the PMD head 16 is useful for changing the pitch of a nozzle assembly with respect to the substrate in order to control the precision of the PMD processes. Further, the optical recognition and correction provided by the PMD system 10 further allows drop size control. Moreover, the PMD system 10 according to the invention provides such uniformity, variability and control in a clean application because the PMD head 16 does not come in contact with the substrate, only the material deposited by the PMD head.

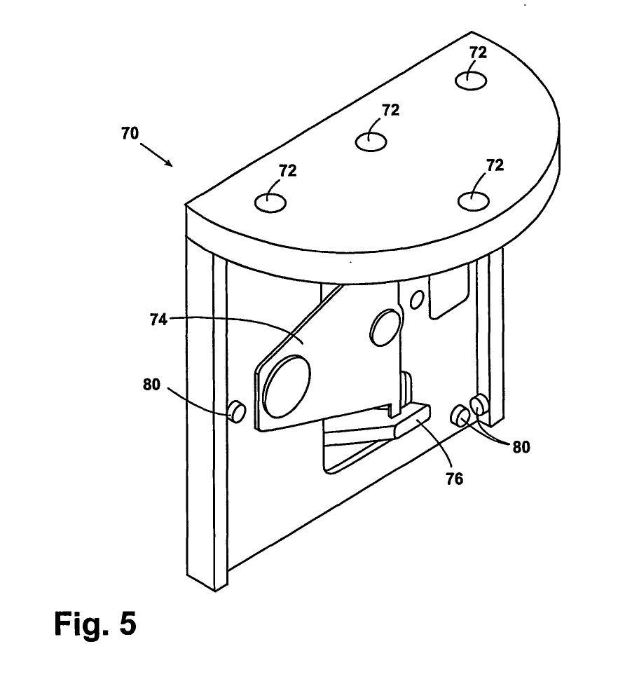

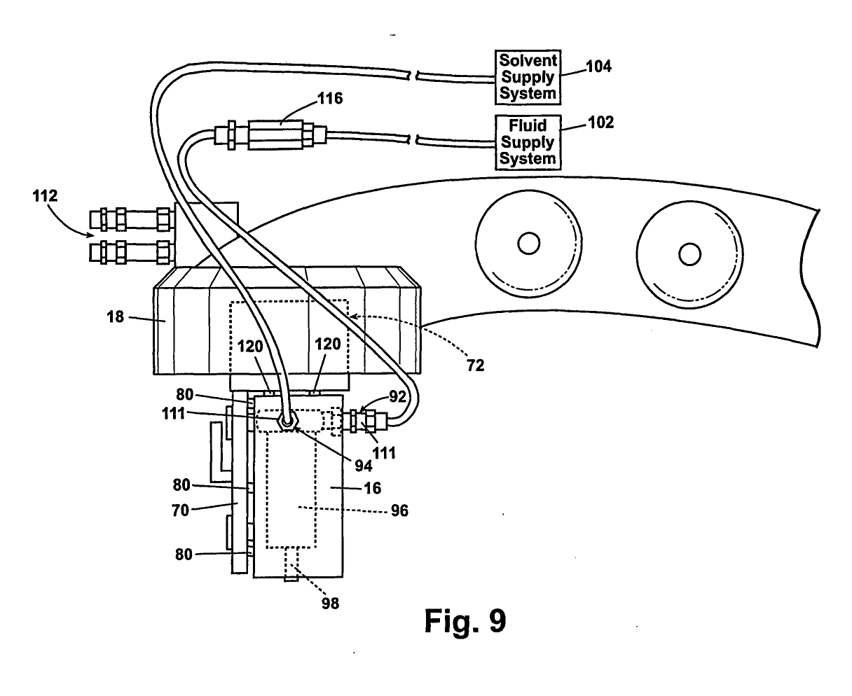

Although alignment of the PMD head 16 with the substrate 38 has thus far been described as a step to be performed after mounting the substrate on the PMD system, it will be appreciated that alignment can also be performed whenever the PMD head 16 is replaced or otherwise mounted on the PMD head support 18. FIGS. 5-7 illustrate a mounting bracket 70 used according to the invention to couple the PMD head with the PMD head support 18. As shown, the mounting bracket 70 includes a plurality of holes 72 through which bolts can pass to secure the mounting bracket 70 to the PMD head support. Further, the mounting bracket 70 includes a latching mechanism 74 that is configured to securely hold the PMD head 16 in placement against the mounting bracket 70. The latching mechanism 74 generally includes latching arms 76 configured to clasp onto corresponding recesses formed in the PMD head 16. The latching arms 76 are operated by a lever 78, shown in FIG. 9, that is located on the opposite side of the mounting bracket 70. The mounting bracket 70 also includes datum points 80 that are used to ensure the PMD head is properly aligned against the mounting bracket 70 when the latching arms 76 secure the PMD head against the mounting bracket 70.

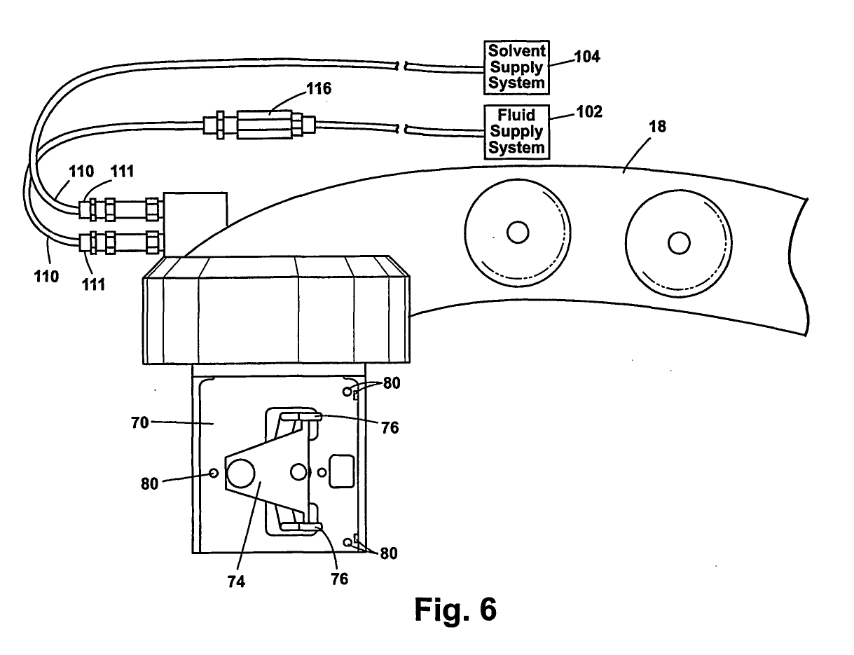

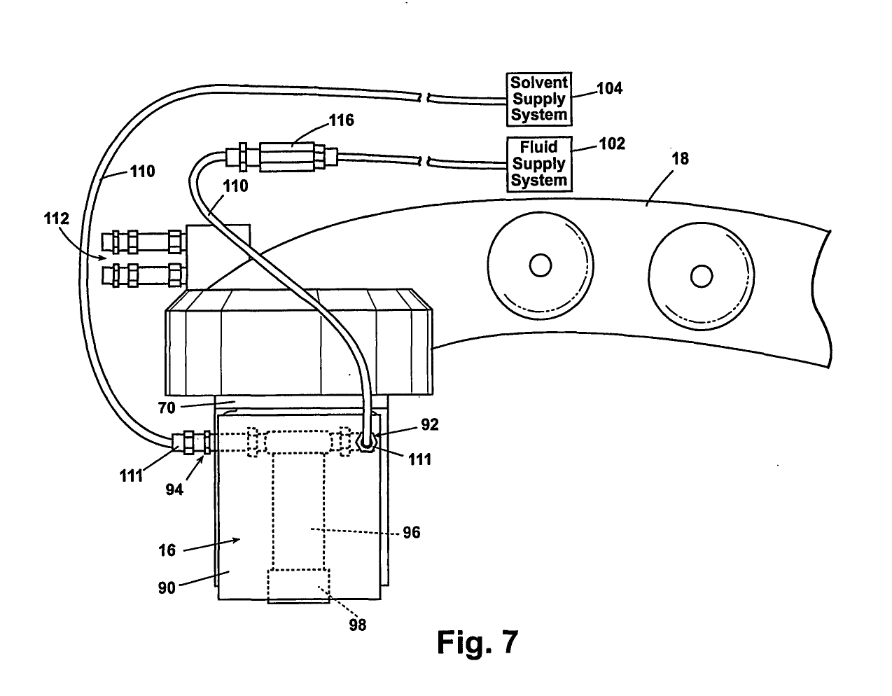

FIG. 7 illustrates one embodiment of a PMD head 16 that is connected with the mounting bracket 70 of FIG. 6. As shown, the PMD head 16 includes a housing 90, a fluid material inlet port 92, a solvent inlet port 94, internal PMD head components 96, and a nozzle assembly 98. During use, fluid material enters the PMD head 16 through the inlet port 92 and is channeled through the internal PMD head components 96 to the nozzle assembly 98 where it is finally discharged onto the substrate through the nozzles of the nozzle assembly 98.

According to one embodiment, the PMD head components 96 include a fluid material reservoir, a diaphragm, and a piezoelectric transducer, such as, for example a Lead Zirconate Titanate: Pb(Zr,Ti)O3, or “PZr” transducer which generates acoustic waves suitable for discharging the fluid material through the nozzles of the nozzle assembly 96. The diaphragm and piezoelectric transducer generates acoustic pulses when power is supplied to the piezoelectric transducer. Droplets of the fluid material are discharged from nozzles included in the nozzle assembly 98 when the force of the acoustic pulses is sufficient to overcome the surface tension of the fluid manufacturing material. The velocity and volume of the discharged droplets are controlled by altering the power supply to the piezoelectric transducer.

The PMD systems of the invention are capable of controlling the volume of the droplets that are discharged from the PMD head 16. According to one embodiment, the PMD head discharges fluid material droplets as small as approximately ten picoliters and at a frequency of up to thousands of droplets per second. Because the desired volume and frequency of the droplets may vary to accommodate different types of fluid manufacturing materials, substrates and microstructure formations, it will be appreciated that the invention is not limited to discharging droplets of fluid materials of any particular volume, frequency, or form.

Conventional ink jet heads (“jet heads”) can be readily adapted for use with at least some fluid materials of the invention. Accordingly, the invention also extends to the use of existing jet heads or jet heads that will be created in the future, including those manufactured currently or in the future by third parties and those that have been or will be manufactured for the purpose of jetting ink in ink jet printing systems.

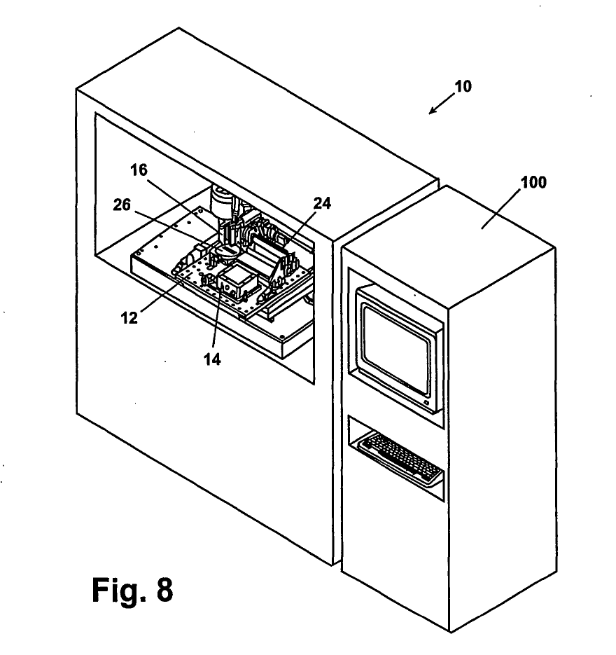

According to one embodiment, the PMD systems 10 of the invention include a computer control system configured to execute computer-executable instruction for generating various digital waveforms, current power supplies, and digital signals, as required by the various print head technologies. The computer system may be physically incorporated within the separate PMD system components, or alternatively, as shown in FIG. 8, the computer system may be embodied as a stand-alone computer system 100 that is connected with each of the different PMD system components, thereby enabling an operator to control each of the PMD system components from the stand alone computer system. The computer system 100 may include the various control systems that are described herein.

One benefit of the computer system 100 is that it more easily enables various PMD heads 16 having different capabilities and functionality to be interchangeably used by the PMD systems 10 of the invention. For instance, according to one embodiment, the computer system 100 separates the electronics of existing print head technologies into two different sections, a master electronics section and a personality electronics section, which can be mounted within the individual PMD heads 16 or the standalone computer system 100.

The master electronics section contains the basic signals and information that are basic to all PMD heads 16; namely, the dot pattern to be deposited (deposition data), a two-dimensional waveform defined by slope, duration, and amplitude, the ground and max voltages used in the PMD head 16, and the clock speed at which the head device is designed for depositing drops of fluid material. The master electronics are typically stored on a computer programmable board that permits these definitions to be made and stored for each type of PMD head 16.

The personality electronics section contains firmware that is specific to certain head manufacturers and models, often requiring custom signals and connections. The personality electronics receives the customized waveforms and data from the master electronics during use. Typically the personality electronics are stored in a computer-readable medium, such as a customized personality card. In one embodiment, a custom personality card is developed for each type of PMD head 16 used by the PMD system 10.

By defining the electronics in this way, the PMD systems 10 of the invention are head independent, thereby allowing interoperability between various PMD heads 16, and thereby enabling the PMD system 10 to accommodate for the various existing and newly developing technologies. In other words, it is possible to replace the PMD heads 16 used by PMD system 10 without having to make any hardware modifications to the PMD system 10. Even piezoelectric heads of different sizes from different manufacturers can be used and incorporated within the PMD heads 16 of the invention, including heads from third parties and those that currently exist or that were originally made to deposit fluid materials other than the fluid materials of the invention. It should be appreciated that this is an advancement over the prior art in which existing piezoelectric heads are designed for a particular head technology and for a single type of piezoelectric head, which limits existing devices from being updated to accommodate new and developing piezoelectric head technologies. Another benefit of defining the electronics in this manner is that it enables the nozzles of the PMD head to be individually controlled to correct any irregularities that may exist.

Returning now to FIGS. 6 and 7, it is shown how tubing 110 is used to interconnect the PMD head 16 with a fluid material supply system 102 and a solvent supply system 104. As shown, the tubing 110 may include quick release fittings 111 that are configured for conveniently moving the tubing 100 from the PMD head 16 to a holding device 112 during periods of nonuse, such as, for example, when the PMD head 16 is being interchanged with another.

FIGS. 6 and 7 also illustrate how a filter 116 may be connected to the tubing 110 to ensure that the fluid material supplied to the PMD head 16 is clean. Although not shown, a filter may also be provided to ensure that the supply of solvent to the PMD head 16 is clean. According to the invention, and as described below in more detail, solvent is supplied to the PMD head 16 to purge the PMD head of a fluid material during purging procedures.

Turning now to FIG. 9, it is shown how the mounting bracket 70 can be rotated with respect to the PMD head support 18. As shown, the mounting bracket 70 has been rotated ninety degrees from the position shown in FIGS. 6 and 7. Rotation of the mounting bracket 70 is enabled, according to the invention, by a turret 72 that is rotatably connected to the bottom of the PMD head support 18. Rotation of the PMD head 16 is useful for facilitating the capture of orthogonal images taken by the drop diagnostics assembly, as described above. Rotation of the PMD head 16 can also be useful for changing the pitch of the nozzle assembly 98 with respect to the substrate in order to precisely control the distance between rows of droplets on a substrate.

FIG. 9 also shows how, according to one embodiment, the datum points 80 bias against the PMD head 16 to ensure alignment of the PMD head 16. The datum points 80 preferably comprise hardened steel capable of providing exact alignment of the PMD head 16 with the mounting bracket 70. Additional datum points 120 may also be provided between the top surface of the PMD head 16 and the mounting bracket 70 to further facilitating alignment of the PMD head 16 with the mounting bracket 70. When the PMD head 16 is not properly aligned in the mounting bracket 70, the drop angle of the droplets fired out of the nozzles may be offset, in which case the drop diagnostics assembly detects and compensates for any misalignment, as generally described above. However, if misalignment is significant, it may be necessary to remount the PMD head 16 on the mounting bracket 70.

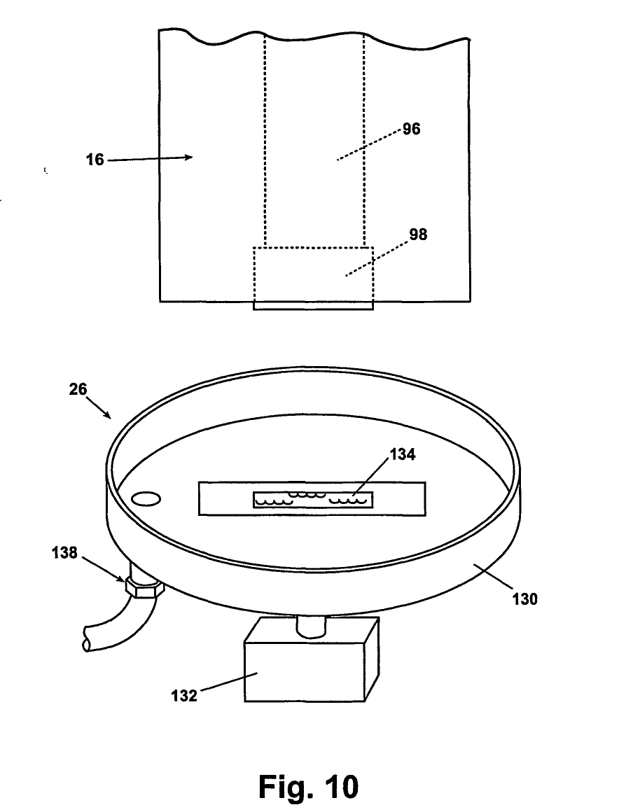

Attention will now be turned to FIG. 10 for providing a detailed description of the capping station 26. As shown, the capping station 26 generally includes a tray 130 mounted on an extendable support 132, and a soaking reservoir 134. One purpose of the capping station is to receive and bathe the nozzles of the PMD head 16 during periods of nonuse to keep the nozzles from drying out and from becoming clogged. For instance, when the PMD head 16 is inactive for a period of time, the capping station 26 is moved directly beneath the PMD head 16 and the tray 130 is elevated by the extendable support 132 until the soaking reservoir 134 engages the nozzle assembly 98 of the PMD head 16. The soaking reservoir 134 is filled with a solvent that is compatible with the fluid material and keeps the nozzle assembly 98 from drying out. The soaking reservoir 134 can be supplied with the solvent by the PMD head 16 or by another supply means, such as, for example, with tubing connected directly to a solvent supply system (not shown).

Another purpose of the capping station 26 is to catch any fluid material deposited from the PMD head 16 during drop diagnostics. For example, during drop diagnostics the fluid material can be dropped onto any portion of the tray 130. Excessive fluid material and solvent falling onto the tray 130 is disposed of through a drain 138 that is connected to the tray 130.

According to one preferred embodiment, the PMD head is interchangeable and can be switched either manually or automatically. In one embodiment, the PMD head includes quick connect fittings and the PMD system includes means for automatically switching the PMD tools. As a matter of example, and not limitation, an interface on a gantry and the corresponding interface on the PMD head represent one suitable means for automatically switching the PMD head. The gantry is an arm to which the PMD head is removably attached. When the PMD head is to be switched with another PMD head, the PMD head is removed from the interface of the gantry, either manually or automatically, and is then placed in a tool holder. The replacement PMD head is then positioned on the interface of the gantry, either manually or automatically. After the new PMD head is attached, the gantry is positioned to a desired location for aligning, testing, and calibrating the PMD head.

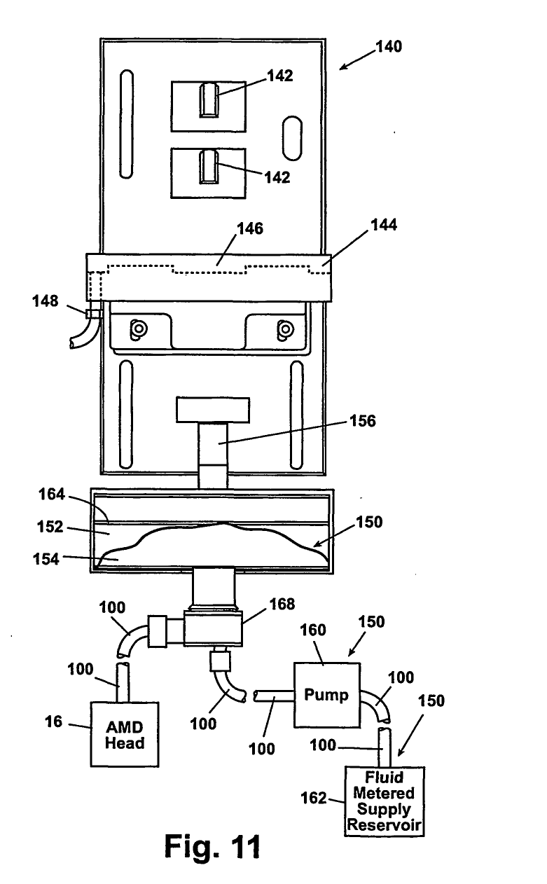

As shown in FIGS. 11-13, a docking station 140 can also be configured for bathing the nozzles of a PMD head 16 during periods of nonuse. The docking station 140 is particularly useful when the PMD head 16 is not going to be used for extended periods of time, or the PMD head 16 is only one of several PMD heads being used with the PMD system. In such circumstances, unused PMD heads are stored on an individual docking stations 140 to prevent the nozzles of the PMD heads from drying out.

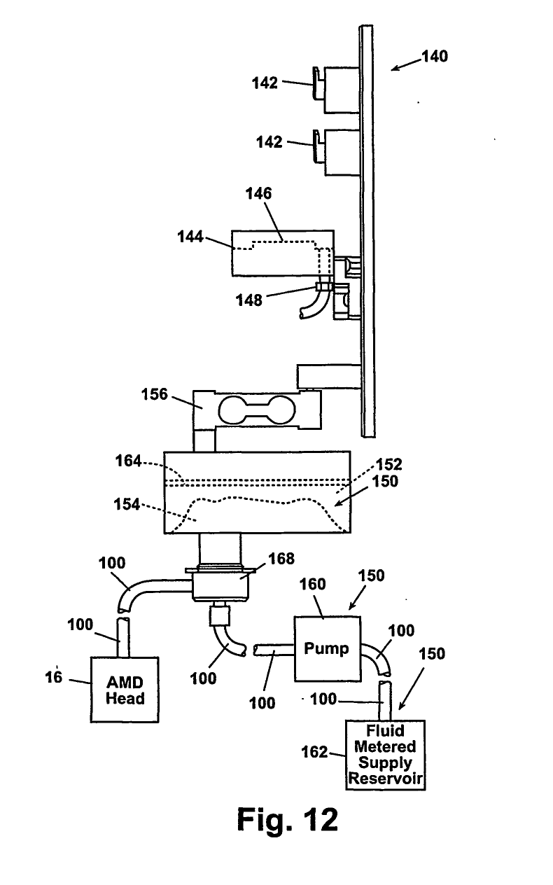

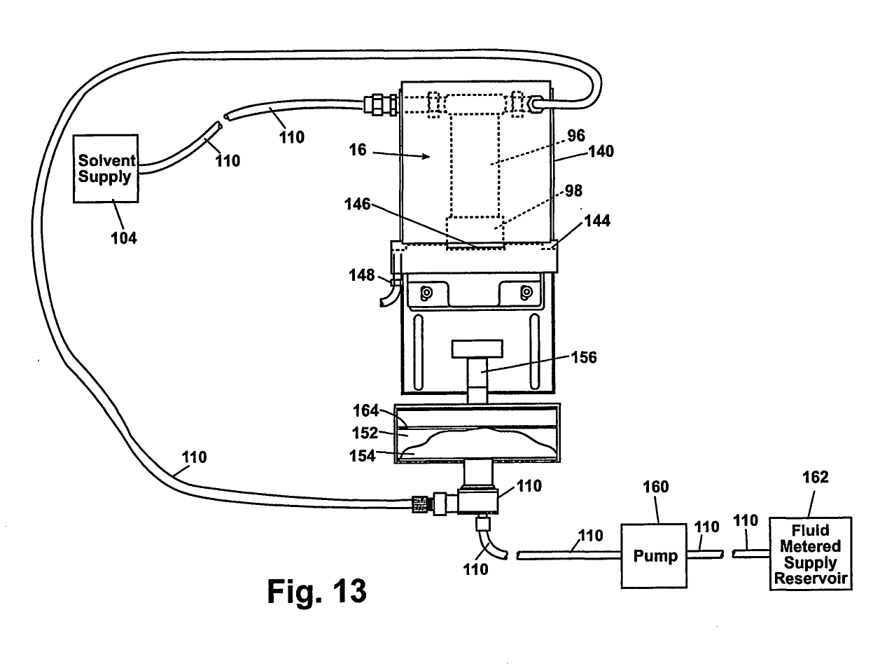

As shown in FIGS. 11 and 12, the docking station 140 includes mounting brackets 142 for receivably mounting the PMD head, a reservoir tray 144, and a soaking reservoir 146. The mounting brackets 142 are configured to securely hold the PMD head 16 in a position that places the nozzle assembly 98 of the PMD head 16 within the soaking reservoir 146, as shown in FIG. 13. The reservoir tray 144 is configured to capture any excessive solvent that spills out of the soaking reservoir during the soaking of the nozzles. The reservoir tray 144 is also configured to capture any fluid material purged from the PMD head during a purging process, as described below. Accordingly, the reservoir tray 144 may also include a drain 148 for draining away any solvent and fluid material captured by the reservoir tray 144 during a purging process. The purged fluid material and solvent can be drained into a storage container (not shown) for easy disposal.

FIGS. 11 and 12 also illustrate how the docking station 140 can be configured to hold a portion of the fluid material supply system 150. In particular, the docking station 140 includes a storage chamber 152 that is configured to hold a working bag 154. During use, the fluid material is initially pumped into the working bag 154, where it is held until it is finally supplied to the PMD head. According to one embodiment, the storage chamber 152 is mounted on a weight gauge 156, which is configured to regulate the amount of fluid material contained within the working bag 154 at any given time. The weight gauge 156 is linked to computer modules and to a pump 160 configured to pump fluid material into the working bag 154 from a fluid material supply reservoir 162. According to one preferred embodiment, a two-way valve 168 controls the flow of the fluid material into and out of the working bag 154.

As shown in FIGS. 11-13, the storage chamber 152 is configured with a pressure control plate 164 configured to apply a predetermined pressure to the working bag 154 so as to ensure the supply of fluid material sent to the PMD head 16 from the working bag 154 is constant. This is important, according to one embodiment, for preventing any meniscus from forming in the fluid material at the nozzles of the PMD head that could potentially cause irregularities in the firing characteristics of the nozzles. According to another embodiment, the pump 160 directly supplies fluid material to the PMD head 16 and regulates the pressure of the fluid material.

According to one embodiment, the fluid material supply system 150, which generally includes the tubing 100, the working bag 154, the pump 160, and the fluid material supply reservoir 162, can be used under various pressures, based on the requirements of the various fluid materials and print head technologies. The materials of the fluid material supply system 150 are preferably configured to be durable and nonreactive with the solvents that are used by the PMD system. For example, according to one embodiment, the fluid material supply system includes an inert lining of polytetrafluoroethylene (such as Teflon®, available from DuPont E. I. DeNemours & Co.), although other materials can also be used.

As mentioned above, one function of the docking station 140 is to hold the PMD head 16 while the fluid material is purged out of the PMD head 16. Purging is sometimes required, for instance, when a single PMD head is used to deposit a variety of different fluid materials during a single PMD process, in which case the PMD head is purged between applications to prevent the different fluid materials from mixing.

To perform a purging procedure, the PMD head 16 is first mounted on the docking station 140, as shown in FIG. 13. Next, solvent is pumped into the PMD head 16 from a supply of solvent 104. The solvent forces the fluid material through the PMD head until the PMD head is completely purged. The fluid material and any solvent purged from the PMD head 16 during this procedure are discharged into the reservoir tray 144 and drained away through the drain 148. Once purged, the PMD head 16 can be connected with a new supply of a fluid material. It will be appreciated that although the purging process has generally been described as occurring at the docking station 140, purging can also occur at the capping station in the substantially same manner.

Returning now to FIG. 1, attention is directed to the maintenance station 24, which includes a roller assembly 170, a cushioned surface 172, and a blotting cloth 174. During use, the blotting cloth 174 is fed through the roller assembly 170 and over the top of the cushioned surface 172. When the PMD head 16 requires servicing, such as when the nozzles become clogged or when fluid material accumulates on the nozzle assembly, the maintenance station 24 is moved below the PMD head 16 so that the cushioned surface 172 is positioned directly beneath the nozzle assembly 98 of the PMD head 16. The cushioned surface 172 is then raised by a lifting mechanism, such as, for example, with the hydraulic lever assembly 176, until the blotting cloth 174 comes in contact with the nozzle assembly 98. This may be sufficient to blot away any fluid material buildup on the nozzle assembly 98. However, sometimes scrubbing is required.

To perform a scrubbing procedure on the nozzle assembly 98, the nozzle assembly 98 is held against the blotting cloth 174 while the blotting cloth 174 is fed through the roller assembly 170. This generally causes the blotting cloth 174 to frictionally engage the nozzle assembly 98, thereby cleaning the nozzles from any undesired buildup. According to one embodiment, the blotting cloth 174 comprises a nonabrasive material suitable for cleaning the nozzles without causing undue damage or wear to the nozzles. To further minimize any potential for damage to the nozzles, the cushioned surface 172 is configured to absorb any impact that could possibly occur between the PMD head 16 and the maintenance station 24.

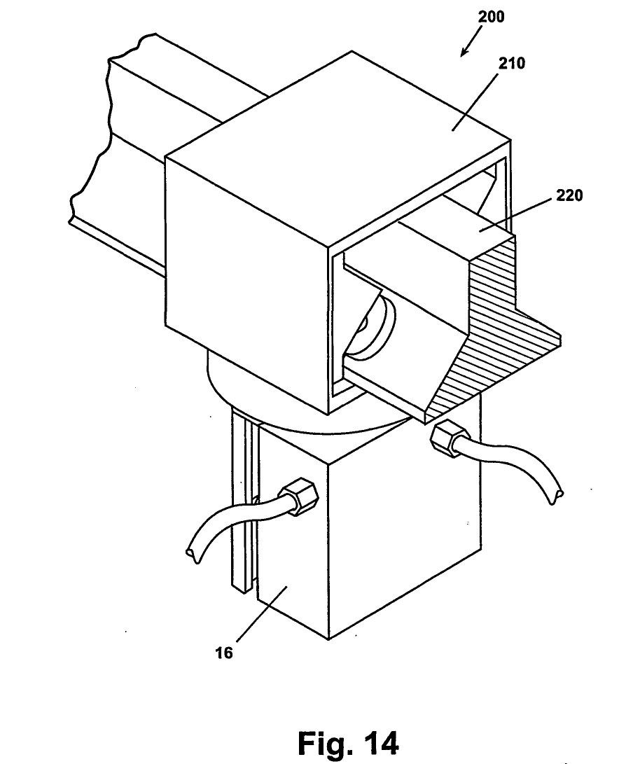

Attention is now directed to FIG. 14 to illustrate one alternative embodiment of the invention. As shown, the PMD head support 200 may include a linear air bearing assembly 210 slidably mounted on a beam 220. The linear air bearing assembly 210 generally includes a linear motor with air bearings. Linear motors, which are well known in the art, utilize magnetic coils and slugs to eliminate friction between moving parts.

The use of the linear bearing assembly 210 is beneficial for enabling PMD processes to be performed in a clean room environment while providing the mobility required for performing PMD processes of the invention on large substrates. In particular, the mobility provided by the linear bearing assembly 210 generally eliminates the need for the stage 12 to completely move each of the PMD components beneath the PMD head 16. Instead, the linear bearing assembly 210 can be used to move the PMD head 16 above the PMD components. The linear bearing assembly 210 can also move the PMD head 16 during deposition of the fluid material on the substrate 38. However, in order to prevent surging of certain fluid materials within the PMD head 16, it is desirable not to move the PMD head 16 while fluid material is being discharged from the PMD head 16. Surging is caused when the fluid material is sloshed around inside of the PMD head, creating Irregular pressures that can effect how droplets are formed and expelled from the nozzles.

One useful application of the invention is to facilitate the manufacture of circuit boards. The PMD systems and processes of the invention can facilitate the manufacture of circuit boards in at least the following ways. First, the PMD processes of the invention can replace the photolithography steps currently used to create traces on a copper-coated fiberglass circuit board. Second, the PMD processes can be used to directly deposit traces of a conductive material onto a substrate to be used as a circuit board. Third, PMD processes can be used to precisely deposit solder pastes and other materials for affixing electronic components to a circuit board. The PMD processes can also provide means for printing necessary information and unique identification onto the circuit board, before or after the board is assembled.

Circuit board traces are conventionally formed in several steps. Initially, a copper-coated fiberglass substrate is treated with a photoresist material. A mask or template with openings is placed over the photoresist material, revealing only the portions of the board where the traces are to be formed. Ultraviolet light is then applied to the photoresist material, curing and hardening the exposed photoresist material. Next, the substrate is cleaned with a compound to remove all of the photoresist material that has not been cured, thereby exposing selected portions of the surface of the substrate. Next, the substrate is exposed to acid etch bathes, one to remove the copper that is not covered by the photoresist material, and one to remove the cured photoresist. This leaves only copper traces that correspond to the openings in the original template.

The present invention eliminates several conventional steps that require directly depositing the photoresist material onto the substrate where the traces are to be formed. For example, in one embodiment, a copper-coated fiberglass substrate is mounted on the stage of the PMD system. Next, the PMD tool deposits a fluid material onto the substrate at the locations where the traces are to be formed. The deposited fluid material operates as a mask on the substrate and replaces the photoresist material that is conventionally used. Next, the substrate is treated with acid etch bath to remove the exposed copper surface of the substrate and a subsequent process to remove the mask formed by the deposited fluid material, leaving only the copper traces below the photo resist.

According to the invention, the entire photolithographic process is eliminated, with the mask being applied directly to the desired locations of the substrate without the need for photoresist material, exposure to ultraviolet light, etc. This simplification of the process saves time and cost in manufacturing the circuit board.

The invention also provides another method for forming traces on a circuit board. In particular, the PMD system of the invention can be used to directly deposit the traces onto a desired substrate. According to this embodiment, the substrate is not copper-coated, and may comprise, for example, a fiberglass board. The fiberglass board is mounted on the stage of the PMD system and the PMD tool is used to deposit conductive fluid material onto the fiberglass board, thereby forming traces.

In one embodiment, a metal solution comprising metal particles is suspended in a fluid binder and the metal solution is deposited onto the substrate. When the binder dries, the metal crystallizes at the location where the traces are to be formed. The substrate and the crystallized metal compound are heated, thereby generating metallic traces on the surface of the substrate.

During the PMD processes for depositing traces, it is preferred that the nozzles of the PMD tool are aligned with the substrate in the direction that the substrate is moving so that tails are precisely lined up beneath each consecutive drop. In some circumstances, however, circuit board traces comprise complex geometries in which the traces are formed at 45 degree and 135 degree angles. In these circumstances, the preferred alignment is achieved by rotating the PMD tool and/or substrate. Accordingly, the PMD tool and/or substrate may rotate to provide the preferred alignment, as described above. The PMD tool and/or substrate may also be rotated to provide a pitch or angle for narrowing the distance between the deposited traces. Pitch and the use of microclocking to accommodate for pitch are described above.

The PMD systems of the invention can also facilitate the manufacture of circuit boards by providing a means for precisely depositing solder pastes or other conductive adhesives to the circuit board so that electronic components can be conductively connected to the circuitry of the circuit board. Assembly machines and existing robotic technologies can be utilized to assemble the electronic components to the circuit board once the solder paste or other fluid materials have been deposited by the PMD system.

It is sometimes desirable to print information on circuit boards relating to manufacture, such as the manufacturers' identification, product specifications, model, serial number, etc. This can be accomplished according to the present invention by using the PMD system to print directly onto the circuit board. For instance, the PMD system may print with ink. Alternatively, an acid can be used to etch the information more permanently into the circuit board. This eliminates the screening or other printing processes used in conventional systems and can be readily adapted to printing different information on each board, since the PMD head is controlled using a computer numerically controlled system.

Another useful application of the invention is to manufacture plastic electronics, such as, for example, resistors and semiconductors. In one embodiment, the PMD systems of the invention are used to deposit high inductance polymers onto a circuit board. The resistance of these high inductance polymers can be designed to vary by composition and by formation. Resistivity, which is a physical property of a conductive material is defined in relation to the resistance measured in a unit cube volume of the material. Specifically, resistivity is defined as the voltage measured across the unit cube's length (V/m) divided by the current flowing through the unit cube's cross sectional area (I/m²), resulting in units of Ohm m²/m or Ohm-m.

Using two or more polymeric materials having different resistivities can enable the PMD processes of the invention to deposit resistors on printed circuit boards having different resistances. For instance, a first polymer could generate a resistor having given dimensions and a 1 ohm resistance, while a second polymer would yield a 100 ohm resistance when used to construct a resistor of the same dimensions. Accordingly, to alter the resistance, different polymers can be selected. The resistance of a resistor deposited on a substrate can be decreased by increasing the volume or thickness of the deposited polymer layer or increased by decreasing the volume or thickness of the layer.

PMD systems can form resistors having predetermined resistances by precisely controlling the deposition of the polymers. The PMD system may also be comprise means, such as electronic circuitry, for testing the resistance of a resistor once it has been formed. If the resistance is too high then additional polymer material can be deposited onto the existing resistor, creating a layered resistor. If the resistance is too low, material can be ablated by laser ablation, as described above.

It should be appreciated by one skilled in the art that applying resistors to a circuit board according to the invention is an improvement over the prior art. In particular, the deposited resistors take up much less volume than typical resistors that have to be attached to a circuit board by connectors that can become disconnected and that cause the resistor to protrude away from the circuit board, thereby increasing the volume of the circuit architecture. It should be also be appreciated that PMD systems and processes can be used to manufacture other types of plastic electronics, such as, for example, polymer semiconductors to further minimize the cost and size of electronic circuitry.

The PMD systems of the invention have thus far been described as being capable of utilizing only a single PMD head at any given time. It will be appreciated, however, that the PMD systems of the invention can also be configured to simultaneously interoperate with multiple PMD heads. For example, the PMD systems of the invention may be configured with multiple PMD head supports, each including a separate PMD head.

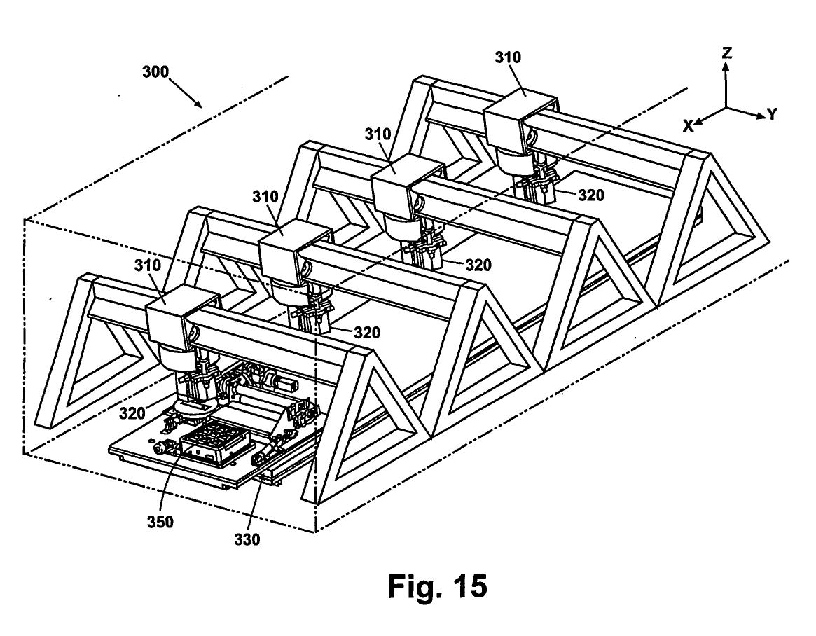

FIG. 15 illustrates such an embodiment, in which a PMD system 300 is configured with multiple PMD head supports 310 and corresponding PMD heads 320 placed adjacently on a single manufacturing line. As shown, the PMD heads 320 are positioned above a stage 330 that is configured to move beneath each of the PMD heads 320 in the X direction of an X-Y plane. Each of the PMD head supports 310 is also configured to move the PMD head in the Y direction of the X-Y plane.

According to this embodiment, each PMD head 320 is configured to deposit a different fluid material from different fluid material supply systems (not shown). This embodiment can be particularly useful depositing any combination of plastic electronics, solder pastes, and liquid metals onto a single substrate 350, such as for example a circuit board. For example, a first PMD head can be equipped to deposit liquid metal for forming traces on the substrate, a second PMD head can be equipped to deposit high impedance polymers for forming resistors on the substrate, and a third PMD head can be equipped to deposit solder pastes for connecting to electronic components that are mounted on the substrate. According to this embodiment, the substrate 350 is moved on the stage 330 sequentially beneath different PMD heads 320 such that the traces are first deposited, then the high impedance polymers are deposited, and then the solder pastes are deposited on the substrate 350. The solder paste is deposited to enable electronic components to be attached to the circuit board.

This embodiment is particularly useful when identifiably unique fluid materials are deposited within close proximity. In particular, this embodiment is useful for enabling identifiably unique fluid materials to dry or cure before another fluid material is deposited within close proximity, thereby preventing the fluid materials from mixing and losing their desired and identifiably unique features. For example, in some circumstances it is desirable to let the traces solidify before the resistors are deposited in close proximity or in contact with the traces. This embodiment is also useful for eliminating the need to flush or purge the PMD heads 320 between applications of the different fluid materials, which can take time. Purging the PMD heads 320 between applications can also be very expensive because the purged fluid material may become contaminated and unusable.

According to one alternative embodiment, multiple separate PMD systems are used sequentially to deposit the different fluid materials on a single substrate, thereby enabling the fluid material to completely dry between the different applications, and thereby eliminating the need to purge the corresponding PMD heads.

According to yet another embodiment, a single PMD head can be used to deposit a variety of different fluid materials. According to this embodiment, the PMD head is purged between uses, as generally described above in reference to FIG. 13.

It should be appreciated that suitable drying time between applications of different fluid materials can also be provided by using a single PMD system that completely applies one fluid material before applying a subsequent fluid material.

For example, in one embodiment, a single PMD system comprises multiple PMD tools that are each integrally connected to a separate bag or supply of fluid material, such that the PMD tools are changed whenever a different fluid material is to be deposited. According to this embodiment, the high impedance polymers, solder pastes, and liquid metals of the previous example are deposited on a circuit board in the following manner. Initially, the liquid metal is deposited to form the traces with a first PMD tool. Next, the high impedance polymer is deposited with a second PMD tool to form the resistors, and finally the solder paste is deposited with a third PMD tool. This embodiment is useful for allowing drying of the fluid material between applications of different fluid materials and it is also beneficial for eliminating the need to flush the system and PMD tool whenever a new PMD tool or fluid material is used. This also allows specialized PMD tools to be used to satisfy the specific requirements of the different fluid materials.

Although the previous examples have gone into some detail regarding specific types of fluid materials and specific sequences for depositing the fluid materials, it should be appreciated that the invention is not limited to the use of fluid materials of any particular composition or to the application of the fluid materials in any particular sequence. For example, the high impedance polymer used to form the resistors can be deposited before the liquid metal is deposited to form the traces. It should also be appreciated that the PMD systems of the invention can be combined with other components and machinery. For example the PMD system may also be combined with an assembly machine to connect electronic components to the deposited solder paste.

Another method for facilitating the drying of fluid material during PMD processes is to provide controlled heating of the fluid material and the substrate. Airflow can also be provided to assist in the drying of the fluid material.

As described above, the substrate can be heated from the vacuum chuck and/or stage by radiation, convection, and/or conduction. The fluid material can also be heated, such as, for example, in the PMD tool. In certain circumstances, the fluid material must be heated before it can assume a viscous form that is suitable for being deposited by the PMD tool, such as, for example, solder pastes, some plastics and metals. In such circumstances, curing or solidifying of the fluid material may involve cooling of the fluid material once it has been deposited on the substrate, in which case the substrate and surrounding environment can be cooled to accelerate the solidifying process of the fluid material. Cooling devices can be connected to the stage to cool the substrate through contact. The substrate can also be cooled by refrigerated ventilation, with refrigerated air or gas is directed at the substrate.

It should be appreciated that cooling and heating of the fluid material and/or substrate is simply one suitable means for controlling the formation of the fluid material on the substrate. In particular, different fluid materials have different properties, some are hydrophobic or hydrophilic, some are oleophobic or oleophilic, some have a fast drying speed others have a slow drying speed. Each of these characteristics, as well as the reactive properties of the fluid materials with other compounds can affect the layer formation of the fluid material once it is deposited on the substrate. Accordingly, the computer-executable instructions of the PMD system can be programmed to adjust the cooling and heating elements of the PMD system to accommodate for the particular type of fluid material, as well as for any other variable that can affect the ultimate form of the deposited material. Other variables include, but are not limited to, deposit velocity, deposit volume, isolation or concentration of deposited material, type and thickness of the substrate, material and texture of the substrate, and the reactivity of the fluid material with the substrate.

Depending on the substrate and the fluid material, heating/cooling or otherwise controlling the environment in which deposition occurs can have various advantages. For instance, expanding the drying temperature range permits the use of otherwise unusable solvents in the process of manufacturing various devices. When jetting fluid materials onto a substrate, drying of the material on the head and the nozzles can clog the nozzles and affect the reliability of the manufacturing process. Heating/cooling the substrate to accelerate drying on the substrate can enable the PMD process to be used with a large variety of fluids that dry slowly at room temperature.

While a variety of techniques for heating/cooling the substrate can be used, one embodiment is performed as follows. The vacuum chuck that secures the substrate is heated/cooled to a temperature selected based on the substrate, the fluid materials, and the nature of the structure being formed. The vacuum chuck is heated/cooled to a specified level of accuracy (e.g., within one degree Celsius) of the selected temperature.

The substrate is allowed to achieve the selected temperature, at which time the fluid material is deposited thereon. The heated/cooled substrate facilitates drying or curing of the fluid material and can improve the formation of layers and, depending on the particular fluid material, can enhance the operation of the structure after the manufacturing process is completed.

If the coefficient of thermal expansion and the temperature to which the substrate is heated/cooled are high enough, the substrate can expand or contract to the point at which a calibration and alignment process performed on the unheated substrate may not be accurate. One of at least two mechanisms can be used to compensate for the expansion and/or contraction. First, if the coefficient of thermal expansion is known, the new position of the entire substrate can be identified based on the original position and the expected expansion or contraction. Second, the optical recognition systems of the invention can be used to recalibrate and align the substrate after heating/cooling. Although either technique can be suitable, the latter is often more accurate, since direct measurement of the position of the substrate is used.

If temperatures are sufficiently high, the vacuum chuck that is heated and in contact with the substrate is thermally insulated from the remainder of the stage of the PMD machine. Such thermal insulation prevents the stage from appreciably expanding, which could otherwise reduce the ability to accurately align and position the substrate with respect to the PMD head.

To increase efficiency, the substrate can be pre-heated or pre-cooled prior to positioning on the chuck, which reduces or eliminates the latency period during which the chuck heats or cools the substrate. Similarly, if continued temperature control after deposition is required, the substrate and the structure formed thereon can be removed from the chuck and placed onto a temperature controlled plate. This technique allows the substrate to be heated/cooled while enabling the PMD system to receive another substrate immediately after processing of the previous substrate.

In certain embodiments, the PMD system also comprises a heating device. The heating device is useful for facilitating the drying, curing, and solidifying of the fluid material once it is deposited on the substrate. The heating device may directly heat the substrate or the environment surrounding the substrate. Heat can be directed to the substrate through radiation, convection, or conduction. By way of example, and not limitation, the vacuum chuck and/or stage can be directly heated by the heating device, thereby providing a source of heat that can be transferred to the substrate. Alternatively, the vacuum chuck and/or stage can be equipped with a heating element or another heat source, thereby operating as the heating device. One skilled in the art will recognize that there are various types of heating elements and devices that can be utilized by the PMD system of the invention to provide heat to the substrate. The heating device can also be configured to provide evenly dispersed or discrete concentrations of heat, as desired. Control of the heating device is particularly useful for controlling the drying pattern and ultimate form of the fluid material once it dries or cures. In particular, the heating device provides one means for controlling the wicking of the fluid material as it solidifies, thereby controlling whether the droplets of the fluid material solidify concavely, convexly, symmetrically, asymmetrically, uniformly, or irregularly.

According to another embodiment, the PMD system is equipped with a curing device, such as an ultraviolet light source for providing a source of ultraviolet light that is directed to the substrate and/or fluid material once it has been deposited on the substrate. This embodiment is useful for curing fluid materials that are cured by ultraviolet light. The curing device may also comprise a laser system. In one embodiment, the laser system is provided as a heat source for curing the deposited fluid material. However, in another embodiment, the laser system is provided as a means for trimming or ablating deposited fluid material. This is useful, for example, to provide an additional means for enabling controlled deposition of the fluid material on the substrate even though laser ablation comprises a post deposition procedure.

Accordingly, the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A method for depositing material on a substrate to manufacture a structure on the substrate, comprising the acts of:
positioning a substrate in a machine capable of performing piezoelectric deposition of a fluid manufacturing material;
aligning the substrate with a piezoelectric deposition head of the machine;
computer numerically controlling relative motion of the substrate and the piezoelectric deposition head as the piezoelectric deposition head deposits droplets of the fluid manufacturing material at selected locations of the substrate, thereby manufacturing a structure on the substrate.

2. A method as recited in claim 1, wherein the act of aligning comprises the acts of:
testing the operation of nozzles of the piezoelectric deposition head by optically analyzing droplets as or after the droplets have been discharged from the nozzles; and
based on the optical analysis, selecting an alignment of the substrate and the piezoelectric deposition head to cause droplets discharged from the nozzles to be deposited at selected locations of the substrate.

3. A method as recited in claim 1, wherein:
the fluid manufacturing material is a conductive fluid material; and
the structure is a trace formed on the substrate.

4. A method as recited in claim 1, further comprising the act of controlling the frequency and timing of deposition of droplets from nozzles of the piezoelectric deposition head.

5. A method as recited in claim 4, wherein the act of controlling the frequency and timing comprises the acts of:
using a microclocking frequency to control the piezoelectric deposition head that is higher than a frequency at which the piezoelectric deposition head is capable of depositing droplets without starvation; and
inserting blank data into selected cycles of the microclocking frequency, so as to increase the temporal resolution at which the timing of deposition of droplets is controlled.

6. A method as recited in claim 1, further comprising the act of heating at least one of the substrate and the piezoelectric deposition head so as to control drying or curing of the fluid manufacturing material after droplets of the fluid manufacturing material are deposited on the substrate.

7. A piezoelectric deposition machine for depositing droplets of a fluid manufacturing material on a substrate to manufacture a structure on the substrate, comprising:
a stage capable of receiving a substrate and securing the substrate;
a gantry;
a piezoelectric deposition head supported by the gantry in a position in relation to the stage such that droplets of the fluid manufacturing material discharged by one or more nozzles of the piezoelectric deposition head can be deposited on the substrate, wherein the stage and the piezoelectric deposition head move relative to one another such that the structure can be formed on the substrate as droplets are deposited on selected locations of the substrate

8. A piezoelectric deposition machine as recited in claim 7, wherein the stage is capable of moving along x and y axes.

9. A piezoelectric deposition machine as recited in claim 7, wherein the gantry is capable of moving the piezoelectric deposition head along one axis.

10. A piezoelectric deposition machine as recited in claim 7, further comprising a computer numerically controlled system for moving the stage and the piezoelectric deposition head relative to one another.

11. A piezoelectric deposition machine as recited in claim 7, further comprising multiple, independently operable, piezoelectric deposition heads.

12. A piezoelectric deposition machine as recited in claim 7, wherein the gantry comprises an interface that enables the piezoelectric deposition head to be removably attached to the interface and enables the piezoelectric deposition head to interoperate with the remainder of the piezoelectric deposition machine.

13. A piezoelectric deposition machine as recited in claim 12, wherein the interface further is capable of receiving other piezoelectric deposition heads having different functionality.

14. A piezoelectric deposition machine as recited in claim 13, further comprising master electronics that enable the piezoelectric deposition machine to interoperate with and control any of said other piezoelectric deposition heads.

15. A method for depositing material on a printed circuit board substrate to manufacture a structure on the printed circuit board substrate, comprising the acts of:
positioning a printed circuit board substrate in a machine capable of performing piezoelectric deposition of a fluid manufacturing material;
aligning the printed circuit board substrate with a piezoelectric deposition head of the machine;
computer numerically controlling relative motion of the, printed circuit board substrate and the piezoelectric deposition head as the piezoelectric deposition head deposits droplets of the fluid manufacturing material at selected locations of the printed circuit board substrate, thereby manufacturing a structure on the printed circuit board substrate.

16. A method as recited in claim 15, wherein:
the printed circuit board substrate has a conductive surface layer; and
the structure on the printed circuit board substrate is a masking structure that exposes selected portions of the surface layer, such that the selected portions of the surface layer can be removed in a subsequent operation, thereby forming traces in the portion of the surface layer covered by the masking structure.

17. A method as recited in claim 16, wherein the masking structure eliminates a photolithography procedure that could otherwise be used to generate a photoresist masking structure.

18. A method as recited in claim 15, wherein the fluid manufacturing material is such that, upon processing after the deposition thereof on the printed circuit board substrate, the fluid manufacturing material becomes a metallic trace on the printed circuit board substrate.

19. A method as recited in claim 15, wherein the structure manufactured on the printed circuit board substrate is a resistor.
